(19) United States
(12) Patent Application Publication
(10) Pub. No.: US 2007/0040953 A1
(43) Pub. Date: Feb. 22, 2007

(54) Pixel structure utilized for flexible displays

(75) Inventors: Yi-Hsun Huang, Hsinchu City (TW); Chih-Ming Lai, Dacun Shiang (TW); Yung-Hui Yeh, Hsinchu City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/236,612

(22) Filed: Sep. 28, 2005

(30) Foreign Application Priority Data
Aug. 19, 2005 (TW) 094128303

(51) Int. Cl. G02F 1/136

(52) U.S. Cl. 349/43

(57) ABSTRACT

A pixel structure utilized for flexible displays, which is suitably disposed on a flexible substrate and is driven by a data line and a scan line, is characterized in that the pixel structure comprises a plurality of thin film transistors. In the pixel structure, the plural thin film transistors are connected by various connection layouts so as to solve the prior-art problem that the pixel structure can't functional normally since the single transistor contained in the pixel structure is damaged by alignment error caused by the deformation in the manufacturing process of the flexible substrate or the buckling of the flexible display while it is being used, and further to improve the reliability of the pixel structure disposed on the flexible substrate.

### FIELD OF THE INVENTION

The present invention relates to a pixel structure, and more particularly, to a pixel structure adapted to be disposed on the flexible substrate of a flexible display, which is capable of effectively improving the reliability of the pixel disposed on the flexible substrate.

### BACKGROUND OF THE INVENTION

The marketplace continues to demand lighter and thinner portable electronic devices. As a result, portable electronic device manufactures require lighter, thinner flat panel displays (FPDs) which are preferred to be flexible or rollable. The attraction of a flexible screen is obvious. Product design, for example, can form a flexible screen in a curve, enabling unheard-of form factors for cell phones shaped like a lipstick or flat TVs that fit in your pocket. Nevertheless, in the situations such as the deformation of a flexible substrate in the manufacturing process of flexible displays resulting in the misalignment among patterns of flexible display, whereas the substrate deformation is caused by thermal expansion, and the buckling of the flexible display while it is being used, the pixel structure of the flexible display might break and thus the flexible display may not be able to function normally.

Generally, in the pixel array of conventional displays, there is only one thin film transistor (TFT) in each pixel structure of the pixel array, whereas the operation of the pixel structure is dependent totally on the condition of its thin film transistor. Please refer to FIG. 1A, which is a schematic drawing showing a pixel structure of a conventional display. As seen in FIG. 1A, one pixel structure selected from the pixel array of a prior-art active matrix display is shown, whereas the pixel structure containing a thin film transistor 130 is disposed on a substrate 100 and is driven by a data line 110 and a scan line 120. Moreover, the thin film transistor 130 is composed of two electrodes 132, an oxide 134, and a silicon material 136 arranged from top to bottom. However, as the deformation of the substrate caused by thermal expansion in the manufacturing process might result in the misalignment among patterns of each pixel structure, and as the buckling of the flexible display while it is being used might damage the pixel structure thereof, in any case, the TFT 130 of each pixel structure will not be able to function normally and thus the pixel structure will have problem to function as expected. Most of the prior-art technology used for solving the aforesaid problems focus on overcoming the snapping of conductive wires and the breaking of capacitors. There is never any effort addressing the problem of TFT breakage, not to mention the fact that there is no way to solve the alignment error caused by deformations in view of pixel design.

Therefore, it is in need of a pixel structure utilized for flexible active/passive displays, which is capable of effectively overcoming the alignment error caused by the deformation of thermal expansion without the need to increase the number of optical masks used in the manufacturing process thereof by improving the layout design of pixel structures, and thus enhancing the reliability of the flexible display.

### SUMMARY OF THE INVENTION

In view of the disadvantages of prior art, the primary object of the present invention is provide a pixel structure with improve layout, which can reduce the probability of pixel damage caused by alignment error in manufacturing process or the buckling of substrate so as to enhance the reliability of pixel array disposed on a flexible substrate.

It is another object of the invention to provide a pixel structure, which utilizes a plurality of layouts without increasing the complexity of its manufacturing process to ensured that at least one thin film transistor arranged therein is capable of functioning normally while subjecting to alignment error or substrate buckling.

To achieve the above objects, the present invention provides a pixel structure utilized for flexible displays, which is suitably disposed on a flexible substrate and is driven by a data line and a scan line, is characterized in that the pixel structure comprises a plurality of thin film transistors. In the pixel structure, the plural thin film transistors are connected by various connection layouts so as to solve the prior-art problem that the pixel structure can't functional normally since the single transistor contained in the pixel structure is damaged by alignment error caused by the deformation in the manufacturing process of the flexible substrate or the buckling of the flexible display while it is being used, and further to improve the reliability of the pixel structure disposed on the flexible substrate. Wherein, the layouts of the plural thin film transistor in the pixel structure of the invention includes: the pixel structure with two thin film transistors, respectively being disposed at different side of the data line while being parallel thereto; the pixel structure with two thin film transistors, both being disposed at a side of the data line while being parallel thereto; the pixel structure with plural thin film transistors, all being disposed at a side of the data line while being parallel thereto; the pixel structure with two thin film transistors, one being disposed parallel to the data line and another one being disposed parallel to the scan line while both being disposed at a side of the data line and perpendicular to each other; the pixel structure with two sets of thin film transistors respectively being disposed at different side of the data line, each set having two thin film transistors disposed perpendicular to each other while one being disposed parallel to the data line and another one being disposed parallel to the scan line; and so on. Furthermore, the flexible substrate can be a plastic substrate or a metal foil substrate; the silicon material used in the thin film transistor can a material of amorphous silicon (i.e. a-Si) or polysilicon (i.e. poly-Si). In addition, the pixel structure of the invention is suitable to be adopted by flexible displays, such as TFT LCD and AMOLED.

In a preferred aspect of the invention, the arrangement of the plural scan lines and the plural data lines forms an interlacing pattern on the pixel array in a way that a pixel structure is defined by any two neighboring scan lines and any two neighboring data lines and each pixel structure of the pixel array comprises at least two independent silicon blocks. Correspondingly, each pixel structure of the invention has at least two thin film transistors connected respectively to its corresponding scan lines and data lines, whereas the thin film transistors can be PMOS transistors or NMOS transistors.

In general, the present invention provides a pixel structure adapted to be disposed on the flexible substrate of a flexible display, being characterized in that the pixel structure comprises a plurality of thin film transistors, instead of only a single thin film transistor in a conventional pixel structure. In the pixel structure, the plural thin film transistors are connected by various connection layouts while enabling any one of the plural thin film transistor to be capable of single-handedly driving the resistors and capacitors loaded in the corresponding pixel structure by itself, so that reliability of the pixel structure can be improved even when damages of alignment error or the buckling of the flexible display are happening, since the pixel structure can be ensured to function normally even when there are only one of its plural thin film transistors is functioning normally.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1A is a schematic drawing showing a pixel structure of a conventional display.

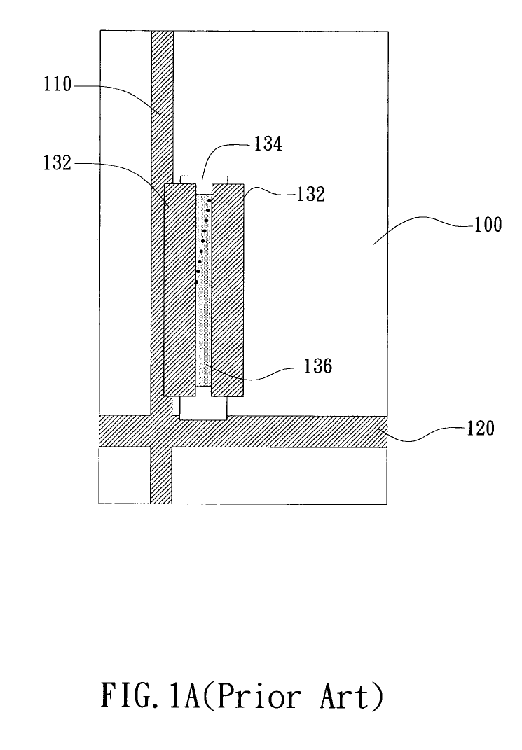

FIG. 1B is a schematic drawing showing a shift-to-right alignment error caused by the deformation of pixel structure in manufacturing process according to prior art.

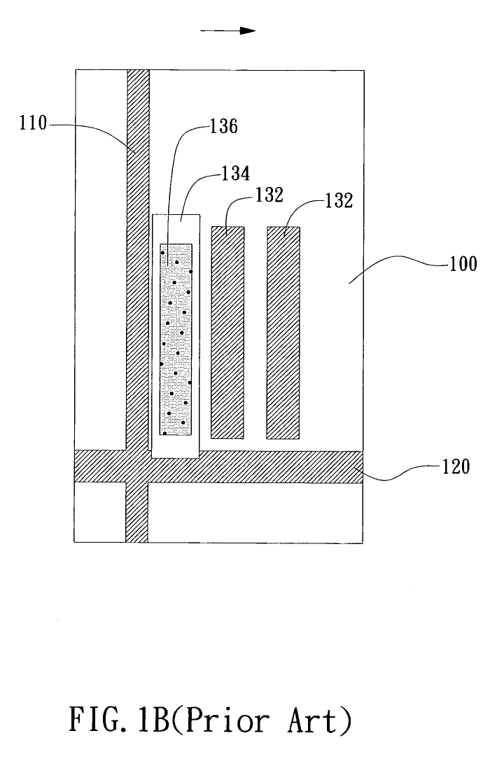

FIG. 1C is a schematic drawing showing a shift-to-left alignment error caused by the deformation of pixel structure in manufacturing process according to prior art.

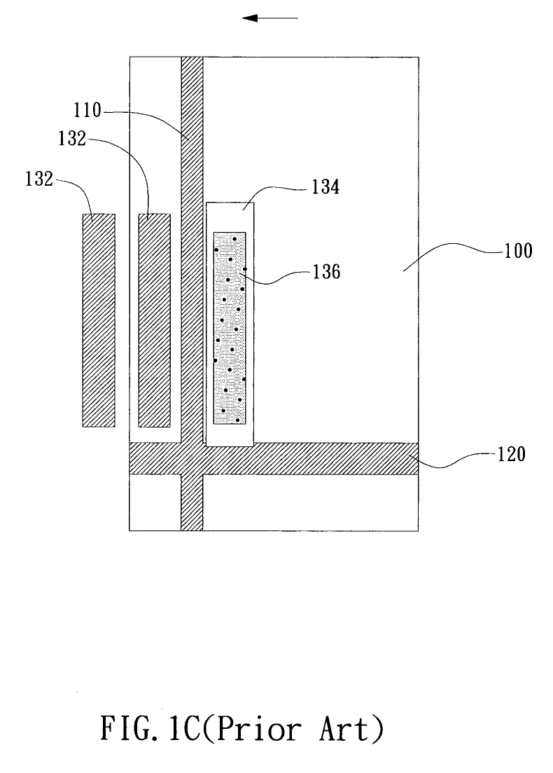

FIG. 2A is a schematic drawing showing a pixel structure adapted for flexible displays according to a first embodiment of the present invention.

FIG. 2B is a schematic drawing showing an alignment error in horizontal direction caused by the deformation of pixel structure in manufacturing process according to the first embodiment of the present invention.

FIG. 2C is a schematic drawing showing an alignment error in vertical direction caused by the deformation of pixel structure in manufacturing process according to the first embodiment of the present invention.

FIG. 3A is a schematic drawing showing a pixel structure adapted for flexible displays according to a second embodiment of the present invention.

FIG. 3B is a schematic drawing showing a shift-to-left alignment error caused by the deformation of pixel structure in manufacturing process according to the second embodiment of the present invention.

FIG. 3C is a schematic drawing showing a shift-to-right alignment error caused by the deformation of pixel structure in manufacturing process according to the second embodiment of the present invention.

FIG. 4A is a schematic drawing showing a pixel structure adapted for flexible displays according to a third embodiment of the present invention.

FIG. 4B is a schematic drawing showing an upward-shifting alignment error caused by the deformation of pixel structure in manufacturing process according to the third embodiment of the present invention.

FIG. 4C is a schematic drawing showing a downward-shifting alignment error caused by the deformation of pixel structure in manufacturing process according to the third embodiment of the present invention.

FIG. 5A is a schematic drawing showing a pixel structure adapted for flexible displays according to a fourth embodiment of the present invention.

FIG. 5B is a schematic drawing showing an alignment error in horizontal direction caused by the deformation of pixel structure in manufacturing process according to the fourth embodiment of the present invention.

FIG. 5C is a schematic drawing showing an alignment error in vertical direction caused by the deformation of pixel structure in manufacturing process according to the fourth embodiment of the present invention.

FIG. 5D is a schematic drawing showing an alignment error in diagonal direction caused by the deformation of pixel structure in manufacturing process according to the fourth embodiment of the present invention.

FIG. 6A is a schematic drawing showing a pixel structure adapted for flexible displays according to a fifth embodiment of the present invention.

FIG. 6B is a schematic drawing showing an alignment error in horizontal direction caused by the deformation of pixel structure in manufacturing process according to the fifth embodiment of the present invention.

FIG. 6C is a schematic drawing showing an alignment error in vertical direction caused by the deformation of pixel structure in manufacturing process according to the fifth embodiment of the present invention.

FIG. 6D is a schematic drawing showing an alignment error in diagonal direction caused by the deformation of pixel structure in manufacturing process according to the fifth embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

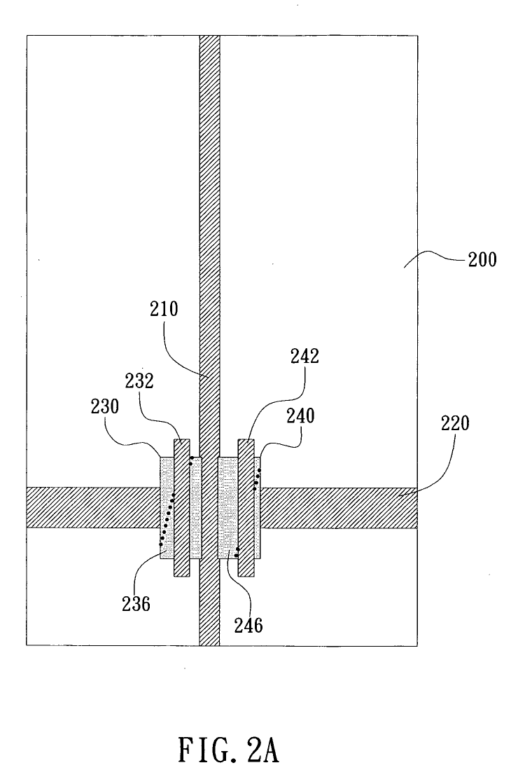

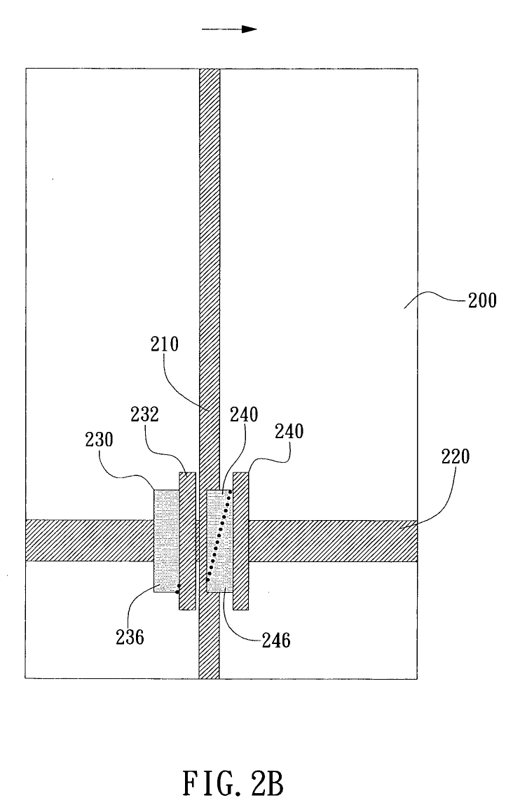

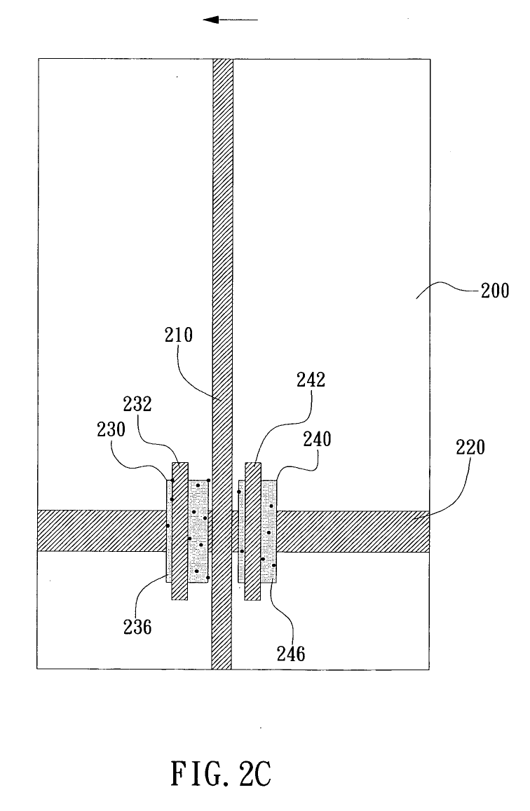

Please refer to FIG. 2A, which is a schematic drawing showing a pixel structure adapted for flexible displays according to a first embodiment of the present invention. The pixel structure of FIG. 2A is adapted to be disposed on the flexible substrate 200 and is driven by a data line 210 and a scan line 220. Moreover, the pixel structure comprises two of thin film transistors 230, 240, respectively being defined on two silicon active regions 236, 246 while using the two electrodes 232, 242 for electric connection. The pixel structure of FIG. 2A is characterized in that two thin film transistors 230, 240 are respectively disposed at different sides of the data line 210 while enabling the channel of each thin film transistor to be parallel to the data line 210. By the disposition of thin film transistors shown in FIG. 2A, even there are misalignments among TFT patterns caused by a certain horizontal deformation in the manufacturing process, as shown in FIG. 2B, there is still at least a thin film transistor capable of working normally while the alignment error is controlling within a specific alignment margin. Similarly, when there are misalignments among TFT patterns caused by a certain vertical deformation in the manufacturing process, as shown in FIG. 2C, there is also still at least a thin film transistor capable of working normally while the alignment error is controlling within a specific alignment margin. In the pixel structure of FIG. 2A, the two thin film transistors 230, 240 are connected and laid out in a way that any one of the two thin film transistors 230, 240 is capable of single-handedly driving the resistors and capacitors loaded in the pixel structure by itself, so that reliability of the pixel structure can be improved even when damages of alignment error or the buckling of the flexible display are happening, since the pixel structure is ensured to have at least one of its plural thin film transistors to operate normally.

Furthermore, the flexible substrate 200 can be a plastic substrate or a metal foil substrate, and the silicon material used in the thin film transistors can a material of amorphous silicon (i.e. a-Si) or polysilicon (i.e. poly-Si). In addition, the pixel structure of the invention is suitable to be adopted by flexible displays, such as TFT LCD and AMOLED, and the thin film transistors can be PMOS transistors or NMOS transistors with respect to actual requirement.

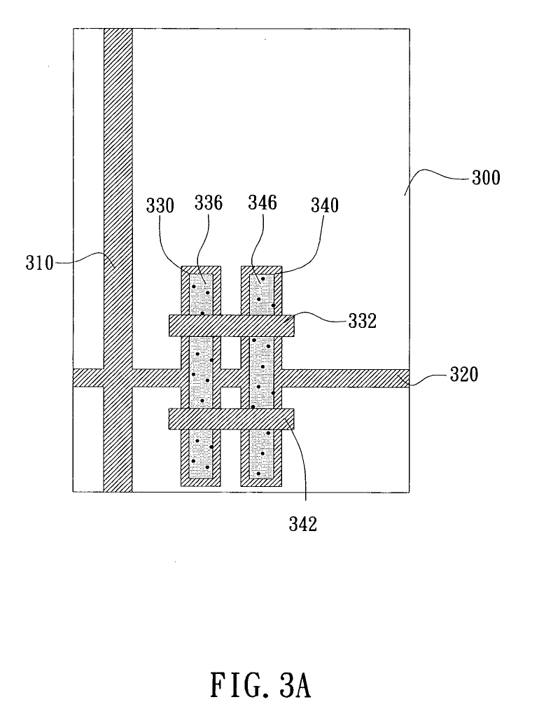

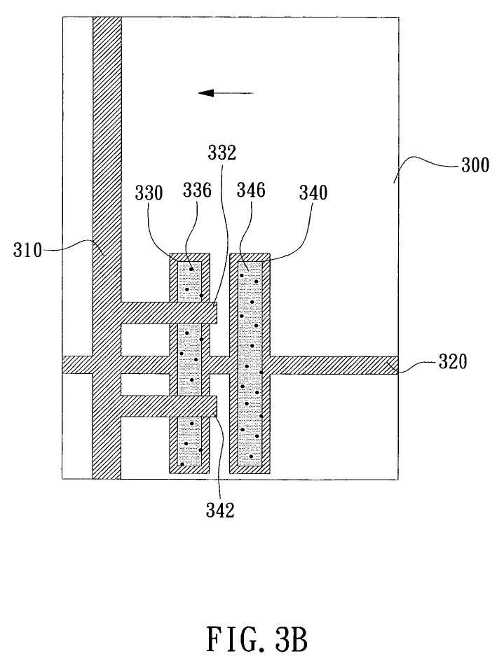

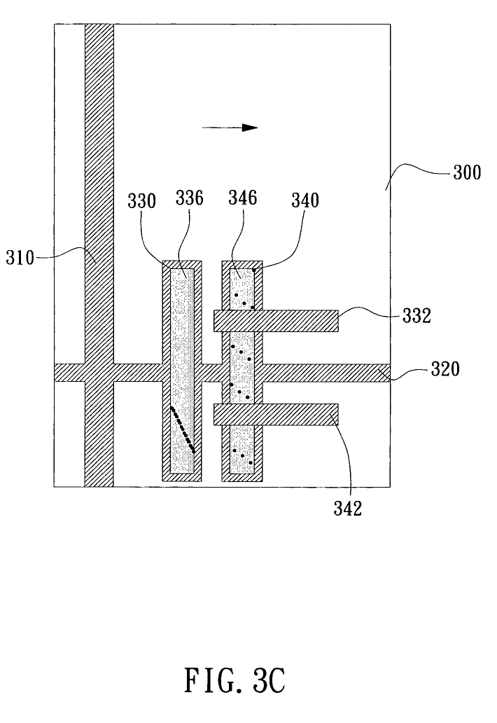

Please refer to FIG. 3A, which is a schematic drawing showing a pixel structure adapted for flexible displays according to a second embodiment of the present invention. The pixel structure of FIG. 3A is adapted to be disposed on the flexible substrate 300 and is driven by a data line 310 and a scan line 320. Moreover, the pixel structure comprises two of thin film transistors 330, 340, respectively being defined on two silicon active regions 336, 346 while using the two electrodes 332, 342 for electric connection. The pixel structure of FIG. 3A is characterized in that two thin film transistors 330, 340 are disposed at a side of the data line 310 while enabling the channel of each thin film transistor to be parallel to the data line 310. By the disposition of thin film transistors shown in FIG. 3A, even there are shift-to-left alignment errors caused by a certain deformation in the manufacturing process, as shown in FIG. 3B, there is still at least a thin film transistor capable of working normally while the alignment error is controlling within a specific alignment margin. Similarly, when there are shift-to-right alignment error caused by a deformation in the manufacturing process, as shown in FIG. 3C, there is also still at least a thin film transistor capable of working normally while the alignment error is controlling within a specific alignment margin. In the pixel structure of FIG. 3A, the two thin film transistors 330, 340 are connected and laid out in a way that any one of the two thin film transistors 330, 340 is capable of single-handedly driving the resistors and capacitors loaded in the pixel structure by itself, so that reliability of the pixel structure can be improved even when damages of alignment error or the buckling of the flexible display are happening, since the pixel structure is ensured to have at least one of its plural thin film transistors to operate normally.

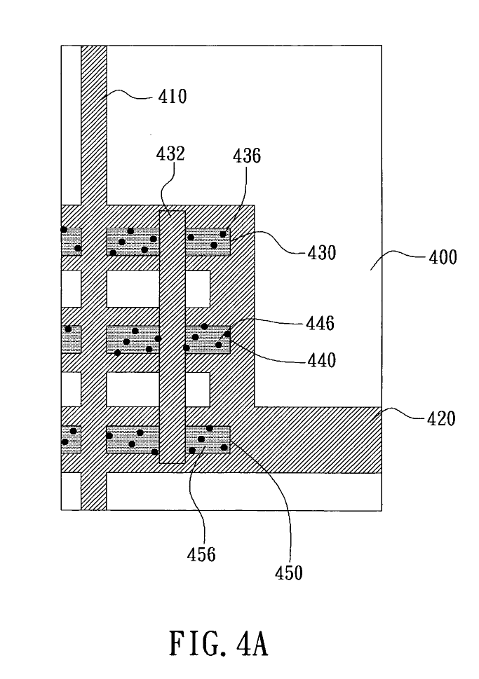

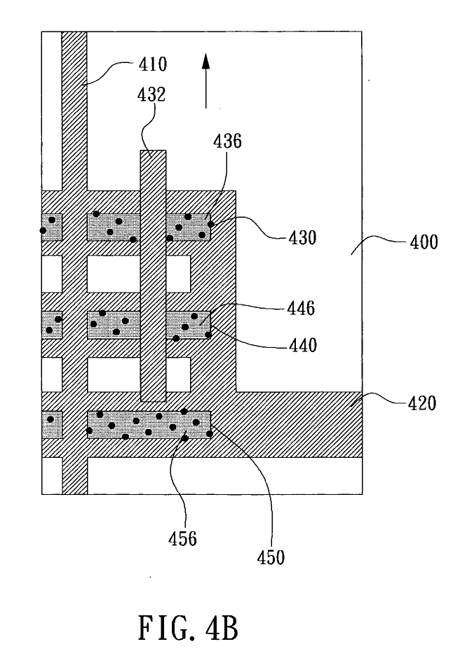

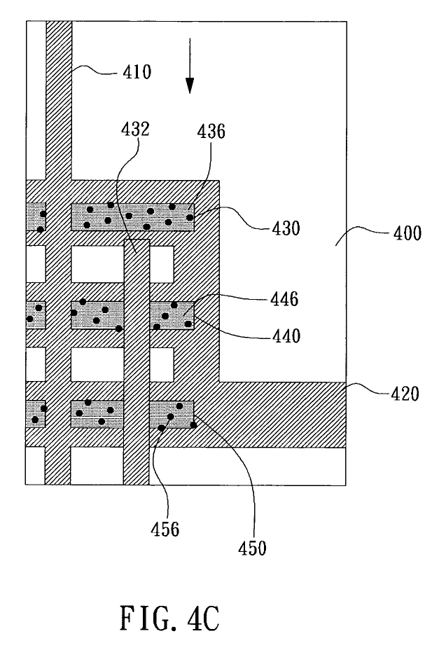

Please refer to FIG. 4A, which is a schematic drawing showing a pixel structure adapted for flexible displays according to a third embodiment of the present invention. The pixel structure of FIG. 4A is adapted to be disposed on the flexible substrate 400 and is driven by a data line 410 and a scan line 420. Moreover, the pixel structure comprises a plurality of thin film transistors, which are represented by the three TFTs 430, 440, and 450 shown in FIG. 4A, respectively being defined on the three silicon active regions 436, 446, 456 while using the electrode 432 for electric connection. The pixel structure of FIG. 4A is characterized in that the plural thin film transistors, i.e. TFTs 430, 440, 450, are disposed at a side of the data line 410 while enabling the channel of each thin film transistor to be parallel to the data line 410. By the disposition of thin film transistors shown in FIG. 4A, even there are upward-shifting alignment errors caused by a certain deformation in the manufacturing process, as shown in FIG. 4B, there is still at least a thin film transistor capable of working normally while the alignment error is controlling within a specific alignment margin. Similarly, when there are downward-shifting alignment error caused by a deformation in the manufacturing process, as shown in FIG. 4C, there is also still at least a thin film transistor capable of working normally while the alignment error is controlling within a specific alignment margin. In the pixel structure of FIG. 4A, the plural thin film transistors are connected and laid out in a way that any one of the plural thin film transistors is capable of single-handedly driving the resistors and capacitors loaded in the pixel structure by itself, so that reliability of the pixel structure can be improved even when damages of alignment error or the buckling of the flexible display are happening, since the pixel structure is ensured to have at least one of its plural thin film transistors to operate normally.

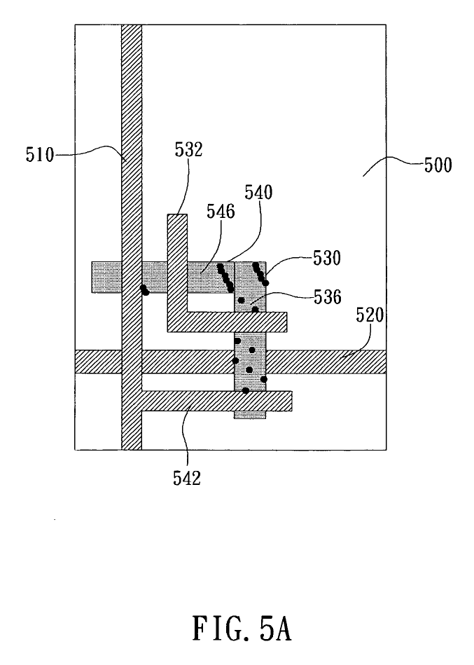

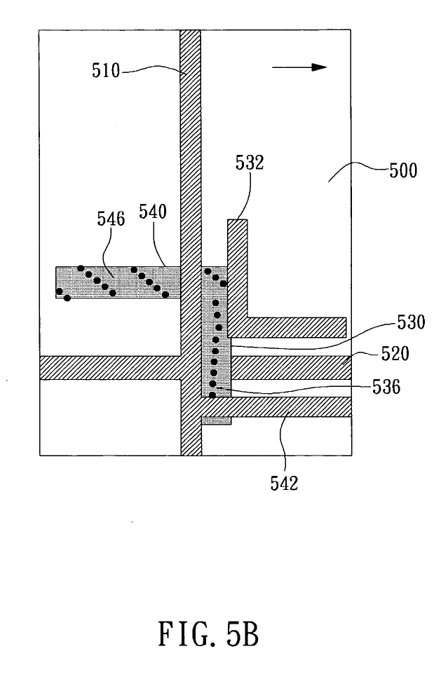

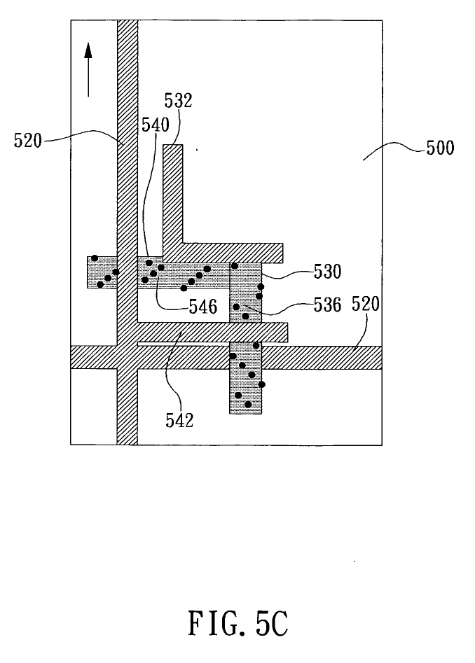

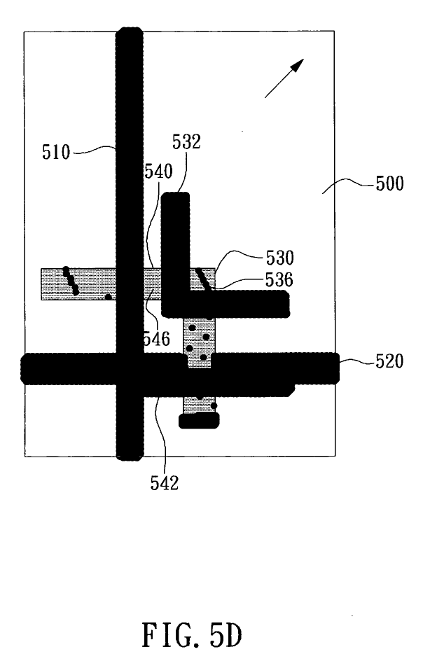

Please refer to FIG. SA, which is a schematic drawing showing a pixel structure adapted for flexible displays according to a fourth embodiment of the present invention. The pixel structure of FIG. 5A is adapted to be disposed on the flexible substrate 500 and is driven by a data line 510 and a scan line 520. Moreover, the pixel structure comprises two of thin film transistors 530, 540, respectively being defined on two silicon active regions 536, 546 while using the two electrodes 532, 542 for electric connection. The pixel structure of FIG. 5A is characterized in that two thin film transistors 530, 540 are disposed at a side of the data line 510 while enabling the channel of one of the two thin film transistors to be disposed parallel to the data line 510 and the channel of another thin film transistor to be disposed parallel to the scan line 520, and the two thin film transistors 530, 540 to be disposed perpendicular to each other so as to form an L-shape formation thereby. By the disposition of thin film transistors shown in FIG. 5A, even there are misalignments among TFT patterns caused by a certain horizontal deformation in the manufacturing process, as shown in FIG. 5B, there is still at least a thin film transistor capable of working normally while the alignment error is controlling within a specific alignment margin. Similarly, when there are misalignments among TFT patterns caused by a certain vertical deformation in the manufacturing process, as shown in FIG. 5C, there is also still at least a thin film transistor capable of working normally while the alignment error is controlling within a specific alignment margin. Furthermore, when there are misalignments among TFT patterns caused by a certain diagonal deformation in the manufacturing process, as shown in FIG. 5D, there is also still at least a thin film transistor capable of working normally while the alignment error is controlling within a specific alignment margin. In the pixel structure of FIG. 5A, the two thin film transistors 530, 540 are connected and laid out in a way that any one of the two thin film transistors is capable of single-handedly driving the resistors and capacitors loaded in the pixel structure by itself, so that reliability of the pixel structure can be improved even when damages of alignment error or the buckling of the flexible display are happening, since the pixel structure is ensured to have at least one of its plural thin film transistors to operate normally.

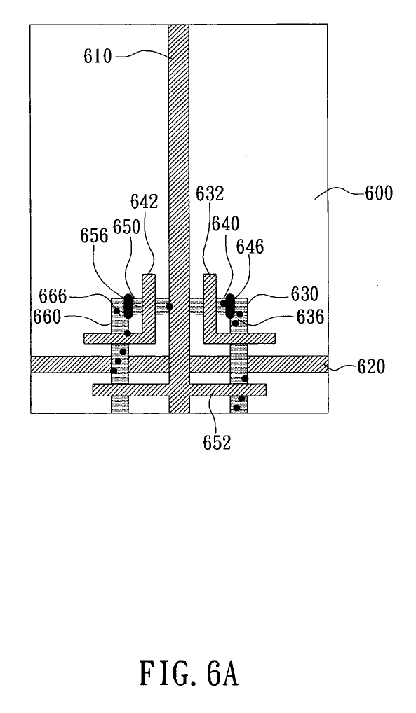

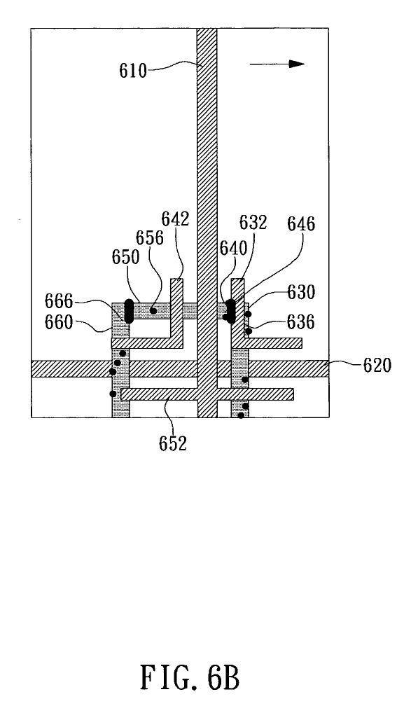

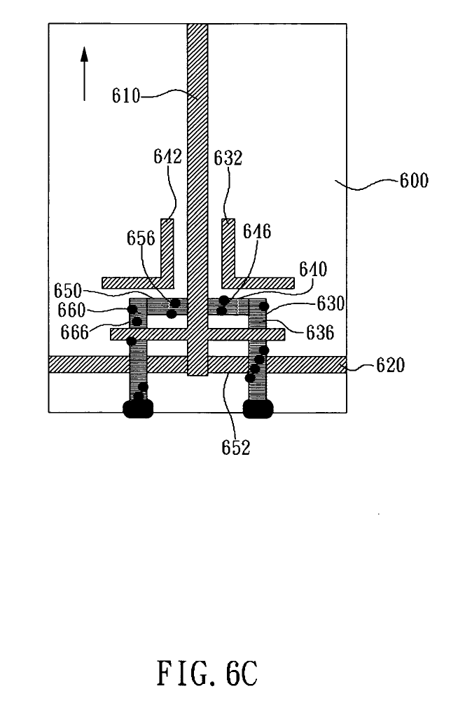

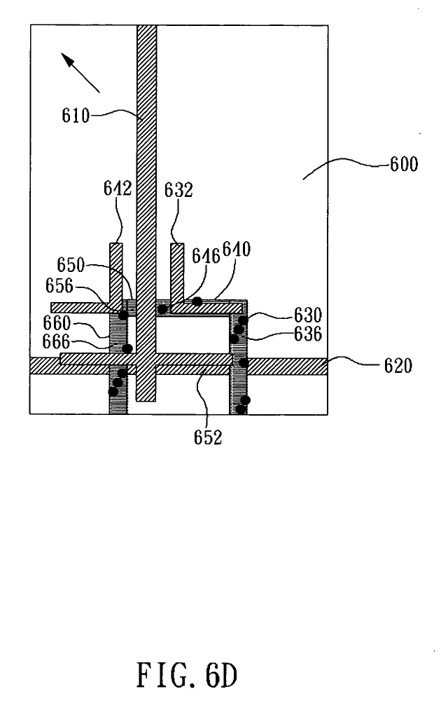

Please refer to FIG. 6A, which is a schematic drawing showing a pixel structure adapted for flexible displays according to a fifth embodiment of the present invention. The pixel structure of FIG. 6A is adapted to be disposed on the flexible substrate 600 and is driven by a data line 610 and a scan line 620. Moreover, the pixel structure comprises two sets of thin film transistors, where the TFTs 630, 640 defined on two silicon active regions 636, 646 are included in the first set while the TFTs 650, 660 on two silicon active regions 656, 666 are included in the second set, and the four thin film transistors 630, 640, 650, 660 use the three electrodes 632, 642, 652 for electric connection. The pixel structure of FIG. 6A is characterized in that two sets of thin film transistors are disposed at different sides of the data line 610, each set having two thin film transistors disposed perpendicular to each other while enabling the channel of one of the two thin film transistors to be disposed parallel to the data line 610 and the channel of another thin film transistor to be disposed parallel to the scan line 620, and further enabling the disposition of the four thin film transistors 630, 640, 650, 660 to form a [symbol] -shape formation. By the disposition of thin film transistors shown in FIG. 6A, even there are misalignments among TFT patterns caused by a certain horizontal deformation in the manufacturing process, as shown in FIG. 6B, there is still at least a thin film transistor capable of working normally while the alignment error is controlling within a specific alignment margin. Similarly, when there are misalignments among TFT patterns caused by a certain vertical deformation in the manufacturing process, as shown in FIG. 6C, there is also still at least a thin film transistor capable of working normally while the alignment error is controlling within a specific alignment margin. Furthermore, when there are misalignments among TFT patterns caused by a certain diagonal deformation in the manufacturing process, as shown in FIG. 6D, there is also still at least a thin film transistor capable of working normally while the alignment error is controlling within a specific alignment margin. In the pixel structure of FIG. 6A, the four thin film transistors 630, 640, 650, 660 are connected and laid out in a way that any one of the four thin film transistors is capable of single-handedly driving the resistors and capacitors loaded in the pixel structure by itself, so that reliability of the pixel structure can be improved even when damages of alignment error or the buckling of the flexible display are happening, since the pixel structure is ensured to have at least one of its plural thin film transistors to operate normally.

From the above description, it is noted that the present invention provides a pixel structure adapted to be disposed on the flexible substrate of a flexible display, being characterized in that the pixel structure comprises a plurality of thin film transistors, instead of only a single thin film transistor in a conventional pixel structure. In the pixel structure of the invention, the plural thin film transistors are connected by various connection layouts while enabling any one of the plural thin film transistor to be capable of single-handedly driving the resistors and capacitors loaded in the corresponding pixel structure by itself, so that reliability of the pixel structure can be improved even when damages of alignment error or the buckling of the flexible display are happening, since the pixel structure can be ensured to function normally even when there are only one of its plural thin film transistors is functioning normally.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A pixel structure adapted to be disposed on the flexible substrate of a flexible display, being driven by a data line and a scan line, the pixel structure comprising a plurality of thin film transistors, each thin film transistor having a gate, a channel and a source/drain, wherein the plural thin film transistors are connectively disposed in the pixel structure by a specific layout.

2. The pixel structure of claim 1, wherein the specific layout arranges two thin film transistors to be respectively disposed at different sides of the data line while enabling the channel of each thin film transistor to be parallel to the data line.

3. The pixel structure of claim 1, wherein the specific layout arranges two thin film transistors to be disposed at a side of the data line while enabling the channel of each thin film transistor to be parallel to the data line.

4. The pixel structure of claim 1, wherein the specific layout arranges at least three thin film transistors to be disposed at a side of the data line while enabling the channel of each thin film transistor to be parallel to the data line.

5. The pixel structure of claim 1, wherein the specific layout arranges two thin film transistors to be disposed at a side of the data line while enabling the channel of one of the two thin film transistors to be disposed parallel to the data line and the channel of another thin film transistor to be disposed parallel to the scan line, and the two thin film transistors to be disposed perpendicular to each other so as to form an L-shape formation thereby.

6. The pixel structure of claim 1, wherein the specific layout arranges two sets of thin film transistors to be respectively disposed at different sides of the data line, each set having two thin film transistors disposed perpendicular to each other while enabling the channel of one of the two thin film transistors to be disposed parallel to the data line and the channel of another thin film transistor to be disposed parallel to the scan line, and further enabling the disposition of the four thin film transistors to form a [symbol] -shape formation.

7. The pixel structure of claim 1, wherein the flexible substrate is a plastic substrate.

8. The pixel structure of claim 1, wherein the flexible substrate is a substrate of metal foil.

9. The pixel structure of claim 1, wherein a silicon material used in the thin film transistor is amorphous silicon.

10. The pixel structure of claim 1, wherein a silicon material used in the thin film transistor is polysilicon.

11. The pixel structure of claim 1, wherein the flexible display is a TFT LCD.

12. The pixel structure of claim 1, wherein the flexible display is an AMOLED.

13. The pixel structure of claim 1, wherein the plural thin film transistors are PMOS transistors.

14. The pixel structure of claim 1, wherein the plural thin film transistors are NMOS transistors.
